(19) United States
(12) Patent Application Publication
(10) Pub. No.: US 2006/0026611 A1
(43) Pub. Date: Feb. 2, 2006

(54) Vibration preventing device and optical disc drive having the same

(75) Inventors: Jeung-rak Lee, Suwon-si (KR); Young-bok Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/986,031

(22) Filed: Nov. 12, 2004

(30) Foreign Application Priority Data
Jul. 28, 2004 (KR) 2004-59214

(51) Int. Cl. G11B 33/08; G11B 33/14; G11B 17/03; G11B 19/20; G11B 17/028

(52) U.S. Cl. 720/651

(57) ABSTRACT

An optical disc drive having a vibration preventing device includes a main frame having sidewalls and a rear wall and guide rails inside the sidewalls; a disc tray with supporting steps to move to a disc loading/unloading position while supported by the guide rails to slide; and four elastic guides to absorb vibration of the disc tray by external impact and/or disc rotation by pressing and supporting the disc tray from up to down elastically, the elastic guides formed in the sidewalls to confront each other with a predetermined space. Since the elastic guides support the disc tray by pressing the disc tray in both sides of the back and front from up to down, the vibration of the disc tray may be prevented effectively. Although the disc tray is ejected to a disc unloading position, the disc tray is not shaken because the disc tray is still supported by two elastic guides.

### CROSS-REFERENCE TO RELATED APPLICATION

This application claims the benefit of Korean Patent Application No. 2004-59214 filed Jul. 28, 2004, in the Korean Intellectual Property Office, the disclosure of which is incorporated herein by reference.

### BACKGROUND OF THE INVENTION

1. Field of the Invention

The present invention relates to a vibration preventing device and, more particularly, to a vibration preventing device to prevent the vibration of devices, such as compact discs (CDs), digital versatile discs (DVDs) and the like, and to an optical disc drive having the vibration preventing device included therein.

2. Description of the Related Art

Generally, optical disc drives to record or reproduce information on or form an optical recording medium such as compact discs (CDs) and digital versatile discs (DVDs), are excellent at reproducing data because these devices record or reproduce data in a non-contact manner by using a pickup unit. However, the optical disc drives using a pickup unit have a shortcoming in that they are weak in vibration. Indeed, recently, as the disc access time of optical disc drives has become even faster, the matter of vibration repression and prevention rises as a significant issue.

FIGS. 1 to 3 illustrate an optical disc drive that includes a conventional vibration preventing device. As shown in FIGS. 1 to 3, the conventional optical disc drive includes a main frame 10 having both sidewalls 1 and 2 and a rear wall 3 and a disc tray 20 placed in the main frame 10. An optical disc (not shown) would be mounted on the disc tray 20. The disc tray 20 may move in and out of the main frame 10 to load/unload a disc.

The main frame 10 includes guide rails 1a and 2a that are formed on the sidewalls 1 and 2 as well as guide grooves 20a and 20b that are formed in the disc tray 20.

One or two guide ribs 3a are formed in the rear wall 3. A tension rib 21 is formed in the disc tray 20 to be elastically brought into contact with the guide ribs 3a when the disc tray 20 moves to a disc loading position.

The tension rib 21 prevents the disc tray 20 from vibrating by absorbing the vibration that is caused by external force and/or the vibration that is generated during the rotation of an optical disc. Thus, vibration-induced noise is not generated.

In the above-described conventional optical disc drive, however, the disc tray 20 may still vibrate in the up and down and right and left directions due to the gap between the guide rails 1a and 2a and the guide grooves 20a and 20b, which are formed for the smooth movement of the disc tray 20. The guide rails 1a and 2a and the guide grooves 20a and 20b will be referred to as a sliding unit collectively herein. Although the conventional optical disc drive has the one or two guide ribs 3a and tension rib 21 to prevent the disc tray 20 from vibrating, the vibration preventing force is substantially neutralized due to the gap in the sliding unit. Therefore, noise may be generated by the vibration.

Moreover, as the disc access time of the optical disc drive becomes much faster as has been the recent trend, vibration generated in the disc tray 20 becomes more serious. This calls for the development of a more effective vibration preventing device.

Further, the conventional optical disc drives adopts a vibration preventing device that supports the rear end of the disc tray 20 against the rear wall 3 of the main frame 10. Therefore, if the disc tray 20 is ejected out of the main frame 10 to a disc unloading position, the disc cannot be supported and moves in the up and down directions. Since this problem may prevent an optical disc drive from becoming a high-quality and high-end product, the problem of having an unsupported disc in the above-noted situation should be solved.

### SUMMARY OF THE INVENTION

Therefore, an object of the present invention provides a vibration preventing device that prevents vibration of a disc tray of an optical disc drive having a fast disc access time by increasing the number of disc tray vibration preventing units.

Another object of the present invention provides a vibration preventing device that may increase the vibration preventing effect and minimize shaking of the disc tray during the ejection of the disc tray by elastically pressing and supporting the disc tray from the upper part thereof to the lower part thereof.

Yet another object of the present invention provides an optical disc drive including the vibration preventing device having the above described characteristics.

In accordance with the above and/or other aspects of the present invention, the present invention may include a vibration preventing device to absorb vibration caused by external impact between a first member having sidewalls and a rear wall and a second member installed in the first member wherein the second member is capable of coming in and out of the first member. The present invention further includes a plurality of elastic guides formed in the first member to press and support the second member elastically in a direction of up to down.

The present invention may also include a vibration preventing device wherein the number of elastic guides is four and the four elastic guides are formed in both sidewalls of the first member to confront each other with a predetermined space.

Here, a fixing groove is formed in an area where an elastic guide is set up on a sidewall, and the elastic guides include a body unit to be inserted to the fixing groove, a tension unit extended from the body unit to be brought into contact with the second member, and a supporting unit formed apart from the tension unit by a predetermined space to be supported against the external side of the sidewall.

The present invention may also include a vibration preventing device including a second vibration preventing unit including a guide rib formed in the rear wall of the first member and a tension rib formed in the second member to be brought into contact with the guide rib elastically when the second member goes to a withdrawal position.

The second vibration preventing unit may include two guide ribs and two tension ribs.

In accordance with another aspect of the present invention, the above objects may be achieved by providing an optical disc drive, which includes: a main frame having both sidewalls and a rear wall and having guide rails in the inner side of the sidewalls; a disc tray having supporting steps in both edges and moving to a disc loading position or a disc unloading position while supported by the guide rails of the main frame to slide; and two pairs of elastic guides for absorbing vibration of the disc tray caused by external impact and/or rotation of a disc by pressing and supporting the disc tray from the upper part to the lower part elastically, the two pairs of elastic guides being formed in the sidewalls to confront each other with a predetermined space.

The vibration of the disc tray may be prevented effectively because two pairs of elastic guides press and support the disc tray from the upper part to the lower part in both sides of the back and front elastically. Even though the disc tray is ejected out to a disc unloading position, the disc tray is still supported by two elastic guides and thus it is not shaken.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view showing an optical disc drive adopting a conventional vibration preventing device;

FIG. 2 is an enlarged view of an essential part of FIG. 1;

FIG. 3 is a cross-sectional view of FIG. 1;

FIG. 4A is a plan view illustrating a main frame of an optical disc drive adopting a vibration preventing device in accordance with an embodiment of the present invention;

FIG. 4B is a side view of FIG. 4A;

FIG. 5 is a perspective view illustrating an elastic guide, which is an essential part, in accordance with an embodiment of the present invention;

FIGS. 6A and 6B are side-sectional views describing a disc tray in a loading and unloading position in the optical disc drive adopting the vibration preventing device in accordance with the present invention; and

FIG. 7 is a front-sectional view of FIG. 6A.

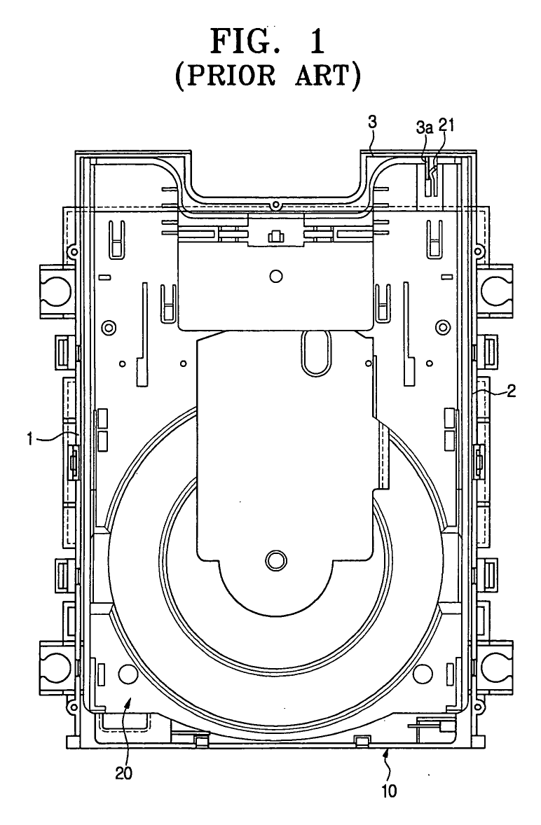

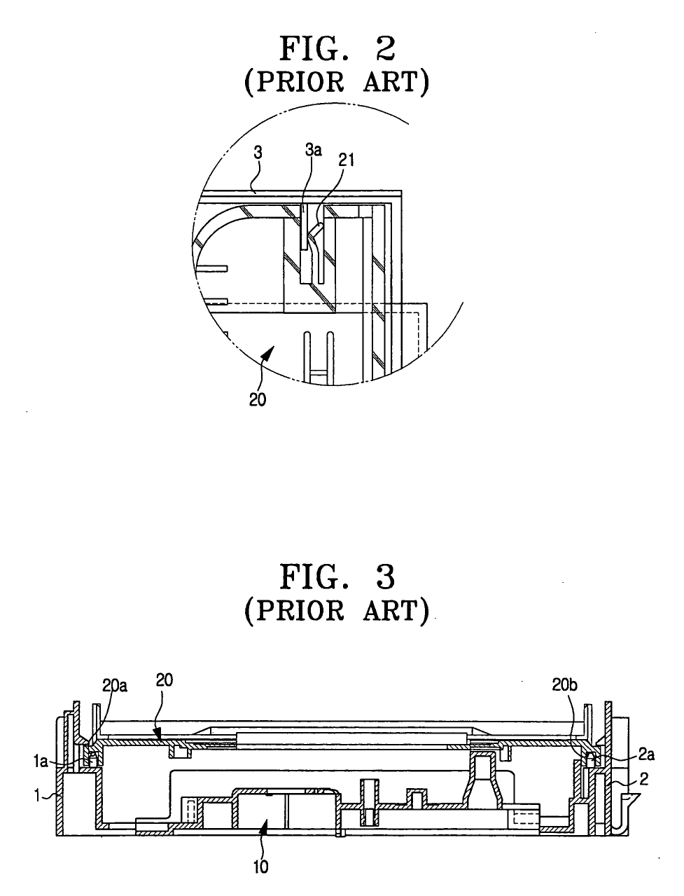

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

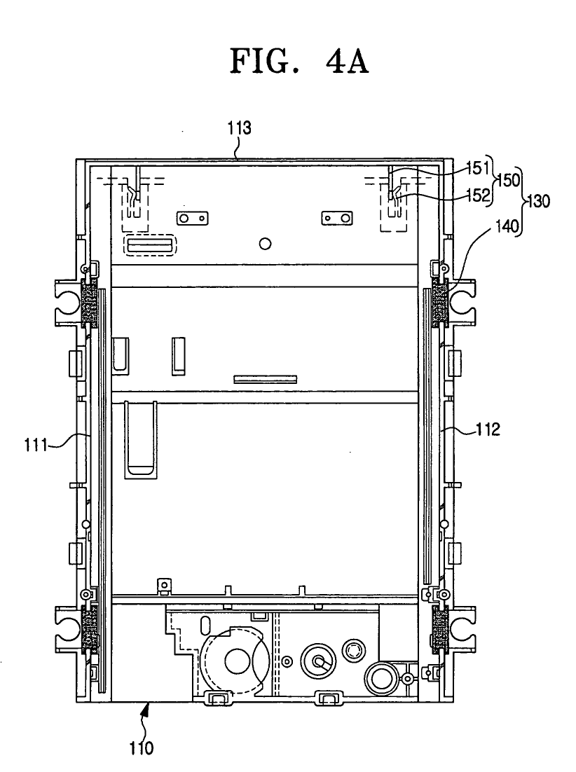

As illustrated in FIGS. 4A through 7, an optical disc drive of one embodiment of the present invention includes a main frame 110, a disc tray 120, and a vibration preventing device formed between the main frame 110 and the disc tray 120 to prevent the disc tray 120 from vibrating by external impact and/or the rotation of a disc.

The main frame 110 includes both sidewalls 111 and 112 and a rear wall 113. The sidewalls 111 and 112 have a fixing groove 111a formed in appropriate positions to set up an elastic guide in the vibration preventing device 130, which will be described later on. A loading mechanism to move the disc tray 120 to the disc loading and unloading positions is placed in an appropriate position. Additionally, a pickup unit to record/reproduce information in the disc is placed in an appropriate position. The structures of the loading mechanism and the pickup unit are not characterized in the present invention and, since they can be understood as generally known technology, further description on them will be omitted herein.

The disc tray 120 formed in the main frame 110 may move in and out of the main frame 110 to the disc loading and unloading positions. An optical disc, which is a recording medium, is mounted thereon. Also, the disc tray 120 has supporting steps 121 formed on both sides thereof. Since a sliding structure (which includes the guide rails 1a and 1b and the guide grooves 20a and 20b as shown in FIG. 3) of the disc tray 120 with respect to the main frame 110 is the same as that of a conventional optical disc drive, detailed description thereof will be omitted herein.

The vibration preventing device 130 is set up in the fixing grooves 11a formed on both sidewalls 111 and 112 of the main frame 110 and includes a plurality of elastic guides 140 to support the disc tray 120 by elastically pressing the disc tray 120 from the upper part to the lower part thereof. The number of the elastic guides is not limited to any number, in particular, but, in an embodiment of the invention, four elastic guides support the disc tray 120 stably by preventing the disc tray 120 from vibrating so that the disc tray 120 is not shaken. The four elastic guides are positioned with two on each sidewall. The two elastic guides on one sidewall confront with those on the other.

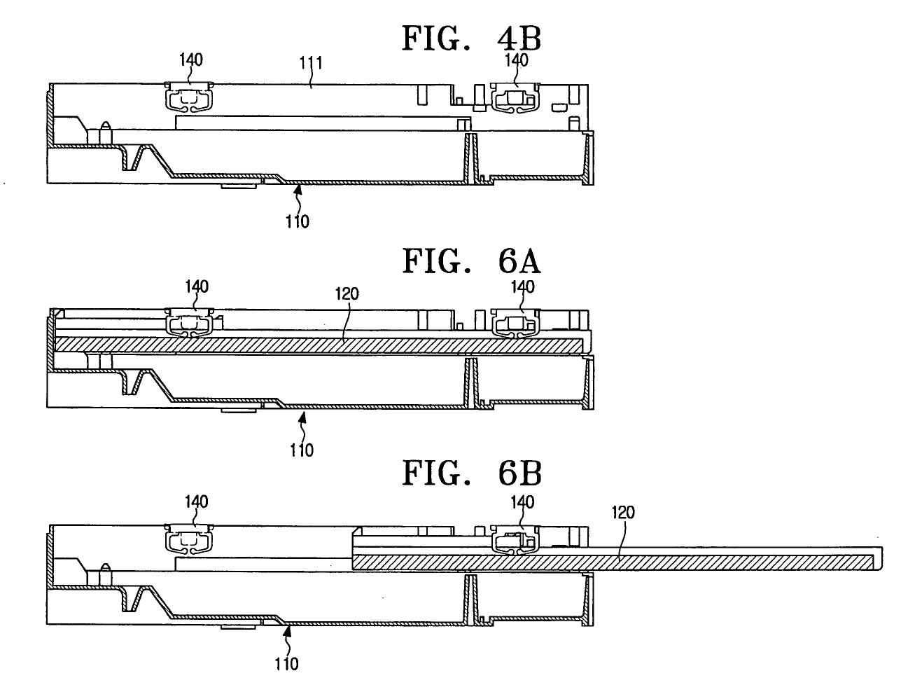

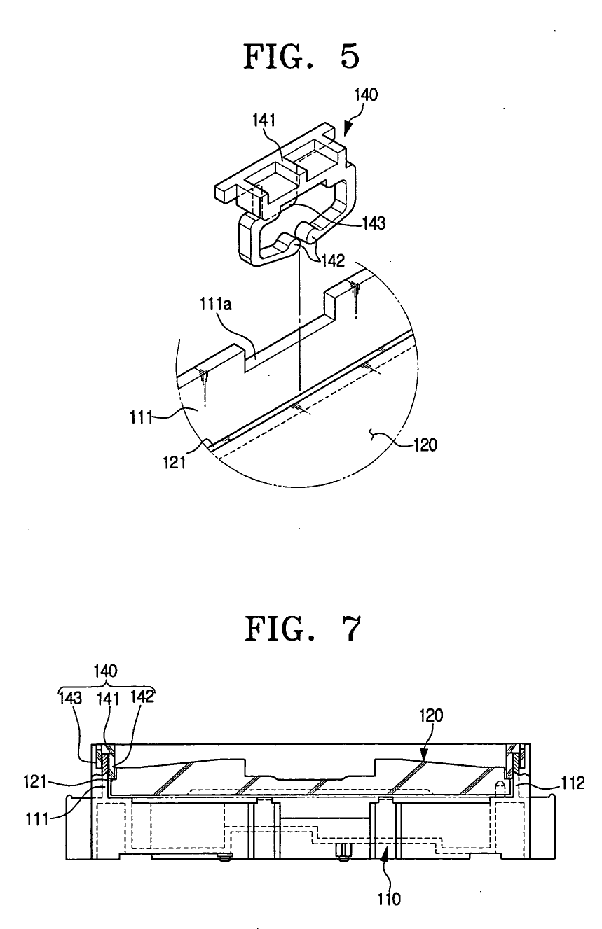

The elastic guides 140 include a body 141, which is inserted to the fixing groove 111a, a tension unit 142 extended from the body 141 to contact the supporting step 121 of the disc tray 120, and a supporting unit 143 formed apart from the tension unit 142 by a predetermined space to be supported by the external side of the sidewall 111 or 112, as illustrated in FIGS. 5 and 7.

The tension units 142 of the four elastic guides 140 are brought into contact with the supporting steps 121 of the disc tray 120 elastically to form four vibration preventing units. Therefore, the vibration of the disc tray 120 may be prevented relatively effectively.

Meanwhile, the vibration preventing device 130 of the present invention may include a second vibration preventing unit 150 having a guide rib 151 and a tension rib 152 similar to that of the prior art to help prevent the vibration of the disc tray 120. Such a guide rib 151 would protrude inwardly from the rear wall 113 of the main frame 110. The tension rib 152 would be formed in the rear end of the disc tray 120 to be brought into contact with the guide rib 151 elastically when the disc tray 120 moves to the disc loading position. In an embodiment of the invention, two guide ribs 151 and two tension ribs 152, are individually formed.

In accordance with the embodiment of the present invention, the disc tray 120 is supported elastically by the four elastic guides 140 from the upper part to the down part and, in the disc loading position, the disc tray 120 is supported by the second vibration preventing unit 150 in the right and left. Therefore, the vibration of the disc tray 120 may be prevented relatively effectively and thus vibration-induced noise may be minimized.

Also, since the two elastic guides 140 in the front of the disc tray 120 continue to support the disc tray 120 elastically even when the disc tray 120 is ejected out to the disc unloading position as shown in FIG. 6B, preventing the disc tray 120 from shaking up and down is possible.

In accordance with the present invention as described above, the vibration of the disc tray 120 may be prevented effectively and thus the noise generated by the vibration may be minimized because two pairs of elastic guides support the disc tray 120 in both right and left of the back and front parts by elastically pressing the disc tray 120 from the upper part to the lower part.

In addition, since the disc tray 120 is supported by the two elastic guides when it is the disc tray 120 is ejected out to the disc unloading position, the disc tray 120 is not shaken, which makes the disc tray 120 a high-quality and high-end product.

Consequently, the present invention provides a high-quality and high-class optical disc drive that has a fast disc access time and is not vibrated or shaken.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A vibration preventing device to absorb vibration caused by external impact between a first member having both sidewalls and a rear wall and a second member formed in the first member to move in and out of the first member, comprising:
a plurality of elastic guides formed in the first member to support the second member elastically from the upper part thereof to the lower part thereof.

2. The vibration preventing device of claim 1, wherein the number of elastic guides is four and the four elastic guides are formed in both sidewalls of the first member to confront each other with a predetermined space.

3. The vibration preventing device of claim 2, wherein a fixing groove is formed in an area where an elastic guide is set up on a sidewall, and the elastic guides comprise:
a body unit to be inserted to the fixing groove;
a tension unit extended from the body unit to be brought into contact with the second member; and
a supporting unit formed apart from the tension unit by a predetermined space to be supported against the external side of the sidewall.

4. The vibration preventing device of claim 1, further comprising:
a second vibration preventing unit including a guide rib formed in the rear wall of the first member; and
a tension rib formed in the second member to be brought into contact with the guide rib elastically when the second member goes to a withdrawal position.

5. The vibration preventing device of claim 4, wherein the second vibration preventing unit includes two guide ribs and two tension ribs.

6. The vibration preventing device of claim 5, wherein the first member is a main frame of an optical disc drive and the second member is a disc tray of the optical disc drive.

7. An optical disc drive, comprising:
a main frame having both sidewalls and a rear wall and having guide rails in the inner side of the sidewalls;
a disc tray having supporting steps in both edges and moving to a disc loading position or a disc unloading position while supported by the guide rails of the main frame to slide; and
two pairs of elastic guides to absorb vibration of the disc tray caused by external impact and/or rotation of a disc by elastically pressing and supporting the disc tray from the upper part thereof to the lower part thereof, the two pairs of elastic guides being formed in the sidewalls to confront each other with a predetermined space.

8. The optical disc drive of claim 7, wherein a fixing groove is formed in an area where an elastic guide is set up on a sidewall, and the elastic guides comprise:
a body unit to be inserted to the fixing groove;
a tension unit extended from the body unit to be brought into contact with a supporting step of the disc tray; and
a supporting unit formed apart from the tension unit by a predetermined space to be supported against the external side of the sidewall.

9. The optical disc drive of claim 8, further comprising:
a second vibration preventing unit including a guide rib formed in the rear wall of the main frame and a tension rib formed in the disc tray to be brought into contact with the guide rib elastically when the disc tray goes to a disc loading position.

10. The optical disc drive of claim 9, wherein the second vibration preventing unit comprises two guide ribs and two tension ribs.

11. An optical disc drive, comprising:
a main frame including sidewalls having inner sides, and a rear wall;
guide rails in the inner side of the sidewalls;
a disc tray to be slidably supported in the guide rails so as to selectively occupy a disc loading position and a disc unloading position; and
elastic guides to substantially evenly and elastically press the disc tray toward the guide rails.

12. The optical disc drive according to claim 11, further comprising fixing grooves in the sidewalls in which the elastic guides are positioned.

13. The optical disc drive according to claim 11, wherein the elastic guides comprise four elastic guides that are positioned with two on each sidewall.

14. The optical disc drive according to claim 13, wherein the two elastic guides on each sidewall opposite to the other two elastic guides.

15. The optical disc drive according to claim 11, wherein the elastic guides comprise:
a body to be inserted into the fixing groove;
a tension unit to extend from the body so as to contact the disc tray; and
a supporting unit formed apart from the tension unit by a predetermined space to be supported by an external side of the sidewall.

16. The optical disc drive according to claim 15, wherein the tension units of the elastic guides elastically contact with the disc tray to form four vibration preventing units.

17. The optical disc drive according to claim 11, further comprising a second vibration preventing unit having a guide rib and a tension rib.

18. The optical disc drive according to claim 17, wherein the guide rib protrudes inwardly from the rear wall of the main frame and the tension rib is formed in the rear end of the disc tray to be brought into elastic contact with the guide rib when the disc tray moves to the disc loading position.

19. An optical disc drive, comprising:
a main frame including sidewalls having inner sides, and a rear wall;
guide rails in the inner side of the sidewalls;
a disc tray to be slidably supported in the guide rails so as to selectively occupy a disc loading position and a disc unloading position; and
elastic guides to substantially evenly and elastically press the disc tray toward the guide rails so as to substantially prevent vibration of the disc tray and to substantially reduce vibration induced noise.

20. An optical disc drive, comprising:
a main frame including sidewalls having inner sides, and a rear wall;
guide rails in the inner side of the sidewalls;
a disc tray to be slidably supported in the guide rails so as to selectively occupy a disc loading position and a disc unloading position; and
elastic guides to substantially evenly and elastically press the disc tray toward the guide rails so as to support the disc tray when the disc tray occupies the unloading position.
